(19) United States
(12) Patent Application Publication
(10) Pub. No.: US 2014/0370463 A1
(43) Pub. Date: Dec. 18, 2014

(54) METHOD FOR PRODUCING A DENTURE

(71) Applicant: HERAEUS KULZER GMBH, Hanau (DE)

(72) Inventors: Karl-Heinz RENZ, Alzenau (DE); Novica SAVIC, Erlensee (DE)

(73) Assignee: HERAEUS KULZER GMBH, Hanau (DE)

(21) Appl. No.: 14/301,478

(22) Filed: Jun. 11, 2014

(30) Foreign Application Priority Data
Jun. 14, 2013 (DE) 10 2013 211 154.1

(51) Int. Cl. A61C 13/00; A61C 13/09; A61C 13/01

(52) U.S. Cl. CPC A61C 13/0004; A61C 13/01; A61C 13/09
USPC 433/199.1; 700/182

(57) ABSTRACT

The invention relates to a method for producing a denture. In one embodiment, a prosthetic baseplate (4) and multiple tooth stump prostheses (6) are produced by applying a CAD model and pre-fabricated veneers (8) are affixed on the tooth stump prostheses (6), whereby the thickness values of the veneers (8) are taken into consideration during generation of the CAD model of the tooth stump prostheses (6). The invention also relates to a denture, in particular fabricated through a method of this type, in which multiple tooth stump prostheses (6) are affixed in a prosthetic baseplate (4) or are structured to be the same part as the prosthetic baseplate (4) and a veneer (8) is affixed in coronal position on at least one tooth stump prosthesis (6), preferably a veneer (8) is affixed in coronal position on each tooth stump prosthesis (8).

This application claims priority of German Patent Application No. DE 10 2013 211 154.1, filed on Jun. 14, 2013, the entire contents of which are incorporated herein by reference.

The invention relates to a method for producing a denture, and to a denture.

The purpose of dentures is to replace the teeth of an edentulous jaw or partially edentulous jaw and to thus restore the mastication function of a patient's mouth as best as possible and to improve the overall aesthetic appearance of the face, in particular of the mouth.

It is common practice to produce dentures in analogue technique. In this context, the teeth are set up manually and individually on a wax base. Said wax prosthesis is then embedded in a cuvette with plaster in the next step in order to wash out the wax base with hot water after the plaster has hardened and generate a hollow space for the prosthetic plastic material.

The teeth remain in the plaster during this process. A corresponding (PMMA) plastic material is injected or “stuffed” into the hollow space and a finished prosthetic baseplate is obtained after the plastic material cures. Setting up the pre-fabricated dentures in the prosthetic baseplate, these are adapted and ground by the dental technician to suit the situation present in the oral cavity of the patient.

The main problem associated with the production of the denture is the positioning of the dental prostheses in the prosthetic baseplate. It is customary to provide or generate for this purpose a perfectly fitting trough in the prosthetic baseplate and then to glue the pre-fabricated teeth into the baseplate. However, this works only if there is sufficient space available and if the dental prostheses do not need to be partially ground from below (basal) or ground off. However, this is rather the exception since the dental prostheses need to be ground for space reasons in the majority of cases. The axial length of the dental prostheses usually needs to be adapted in order to generate an optimal occlusal plane (plane, in which the teeth or dental prostheses of the upper and lower jaws contact each other while the mouth is closed). In these cases, the dental prostheses usually no longer fit into the pre-produced troughs in the prosthetic baseplate.

It has been known, as of late, to set-up dentures as partial prostheses or total prostheses by digital means and to produce them by means of CAD methods (“computer aided design” methods). A method is known from WO 2012/152735 A1, in which artificial teeth are produced by generating a set of data for a three-dimensional CAD model by means of recording a surface scan, and the artificial tooth is generated based on the CAD Model (“computer-aided manufacturing” method) using a CAM method (“computer-aided manufacturing” method).

One disadvantage of this procedure is that the aesthetic appearance of a dental prosthesis made by a CAM method is sub-optimal unless there are further post-processing steps involved, such as polishing and colouring the dental prosthesis. Moreover, the rough surface of the dental prosthesis can favour the adhesion of food residues. Moreover, due to the build-up proceeding layer-by-layer, CAM methods are usually associated with the physical properties of the dental prosthesis being directional, which is not desired. Finally, one is limited in the selection of materials in CAM methods (for example for use with 3D printers) and has no access to particularly hard and lightweight transparent materials, such as ceramic materials, which best generate the optical impression of a real tooth and provide the functionality of a real tooth.

Accordingly, it is the object of the invention to overcome the disadvantages of the prior art. Specifically, a method for producing a denture, and a denture are to be found, in which the dental prostheses no longer need to be subjected to basal grinding for fitting the dental prostheses into the prosthetic baseplate and in which no post-processing of the denture is required in order to produce the desired optical impression and functionality of the denture. Moreover, it should be feasible to use basically all desired materials and the dental prosthesis should not be weakened by undesired directional properties.

The objects of the invention are met by a method for producing a denture, in which a prosthetic baseplate and multiple tooth stump prostheses are produced through the application of a CAD model and pre-fabricated veneers are affixed on the tooth stump prostheses, whereby the thickness values of the veneers are taken into consideration during the generation of the CAD model of the tooth stump prostheses. A veneer may be in the form of a veneer shell, veneering shell or veneering cap.

According to the invention, the prosthetic baseplate and the tooth stump prostheses can be produced to be one single part. Preferably, the tooth stump prostheses are produced separate from the prosthetic plate and are subsequently inserted, preferably glued, into the prosthetic plate. In the process, the axial lengths of the tooth stump prostheses can be adjusted by shortening, in particular by grinding off or cutting off, pre-fabricated tooth stump prostheses on the side facing the prosthetic baseplate or on the opposite coronal side of the pre-fabricated tooth stump prostheses. For a CAD model of the tooth stump prostheses, it is then already sufficient to exclusively model the axial length of the tooth stump prostheses. However, according to the invention, at least the axial length of the tooth stump prostheses must be modelled.

For this purpose, the external shapes of the tooth stump prostheses should be known and given and the coronal surfaces of the tooth stump prostheses must fit the corresponding veneers. The CAD model of the tooth stump prosthesis is then a one-dimensional CAD model since it models just the axial length of the tooth stump prosthesis. According to the invention, the pre-fabricated tooth stump prostheses are then shortened in computer-aided manner using a CAM method.

Alternatively, the tooth stump prostheses having the desired axial length can be fully manufactured from a three-dimensional CAD model of the tooth stump prostheses using a CAM method.

The direction terminology for teeth known from dentistry shall be used in the present and hereinafter for tooth stump prostheses as well.

The thickness of the veneers refers to the thickness of veneer material between the occlusal surfaces and the coronal contact surfaces of the tooth stump prostheses (connecting surfaces for connecting the tooth stump prostheses to the veneers).

For a full denture for the upper jaw and the lower jaw, two prosthetic baseplates each with multiple tooth stump prostheses are produced.

Methods according to the invention can provide that the axial lengths of the tooth stump prostheses of the CAD model are adjusted as a function of the thickness values of the veneers, preferably in that the tooth stump prostheses having the desired axial lengths are made from the CAD model, particularly preferably by means of a CAM method.

This already is sufficient to implement the desired occlusal plane even if pre-fabricated veneers are used. The method is then particularly easy to carry out without major computing efforts.

A further development of the invention proposes to take the shape of connecting surfaces of the veneers into consideration in the generation of the CAD model of the tooth stump prostheses, preferably during generation of the virtual CAD models of the coronal surfaces of the tooth stump prostheses.

The connecting surfaces of the veneers are intended to connect the veneers to the tooth stump prostheses. The connecting surfaces of the veneers are situated opposite from the occlusal surfaces of the veneers.

All coronal surfaces of the tooth stump prostheses to the veneers can be defined, according to the invention, as coronal surfaces in the three-dimensional CAD models of the tooth stump prostheses, since the connecting surfaces of the pre-fabricated veneers to the tooth stump prosthesis are defined and known. For this purpose, the data of the three-dimensional surfaces of the connecting surfaces can be stored electronically and included in the computation of the 3D CAD models. A requisite thickness of adhesive layer required for connecting the veneers to the tooth stump prostheses can also be taken into account according to the invention.

Even though said methods are somewhat more laborious in terms of the computing power needed, a method of this type can be used to easily print out, largely automatically, an almost complete and almost finished denture without any need to stock-keep pre-fabricated products.

A further development of the method according to the invention proposes that the axial lengths of the tooth stump prostheses thus generated are determined by the thickness of the veneers and the desired location of the occlusal plane of the denture with respect to the contact surface of the prosthetic baseplate.

Taking into consideration the desired position of the occlusal plane relative to the alveolar ridges of the upper and lower jaw, allows the axial lengths of the tooth stump prostheses to be determined very accurately such that the denture thus generated can be produced at high accuracy.

A particularly preferred embodiment of a method according to the invention comprises, in chronological order, the following steps of:

A Recording the situation inside the oral cavityoral cavity and determining the position of the desired occlusal plane in the oral cavity of a patient;

B digitising the recorded situation in the oral cavity and position of the desired occlusal plane;

C generating a virtual CAD model of the prosthetic baseplate and of the plurality of tooth stump prostheses, whereby the contact surface of the virtual CAD model of the prosthetic baseplate is determined based on the existing situation in the oral cavity;

D producing a prosthetic baseplate and a plurality of tooth stump prostheses based on the CAD model; and

E affixing the veneers on the tooth stump prostheses.

This specifies a complete method for producing a denture.

The invention can provide that at least the shape of the alveolar ridge surface of the upper jaw and/or of the lower jaw as well as its/their position(s) with respect to the occlusal plane is recorded and digitised as situation in the oral cavity, and that the contact surface of the virtual CAD model of the prosthetic baseplate is computed from the digitised alveolar ridge surface.

Likewise, methods according to the invention can provide the tooth stump prostheses to be produced based on the CAD model, preferably through the use of a CAM method, and the veneers to be affixed to the designated tooth stump prostheses, preferably to be glued onto the designated tooth stump prostheses.

This results in a simplification of the production of the dentures according to the invention.

The invention can provide the prosthetic baseplate and the tooth stump prostheses to be fabricated as separate parts with separate CAD models and the tooth stump prostheses thus produced to be affixed, preferably glued into, the prosthetic baseplate thus produced.

In this refinement, both the tooth stump prostheses and the prosthetic baseplate can be processed subsequently. Moreover, these can then be fabricated from different matching materials.

A further development of the method according to the invention proposes that one prosthetic baseplate each for the upper jaw and one prosthetic baseplate for the lower jaw are produced based on the same occlusal plane, and that the denture is fabricated to have a denture component for the upper jaw and a denture component for the lower jaw.

This renders the method easy to implement and avoids unnecessary steps.

Moreover, the invention can provide the veneers to cover the tooth stump prostheses completely in occlusal direction, preferably cover them completely in occlusal and buccal directions, particularly preferably cover them at least partly in approximal direction.

The veneers thus protect the tooth stump prosthesis and ensure a pleasant overall aesthetic impression.

The invention can just as well provide the prosthetic baseplate and/or the tooth stump prostheses to be fabricated from a plastic material, preferably from PMMA.

Plastic materials can be processed well and can be converted well with modern CAM methods.

According to a further development, the invention can provide the connecting surfaces of the veneers to have an indexed structuring and the surfaces of the tooth stump prostheses provided for the connecting surfaces of the veneers to have a matching indexed structuring, preferably the tooth stump prostheses to be produced to have said matching indexed structuring, and the veneers to be joined to the tooth stump prostheses via the indexed structured surfaces and the veneers to thus be oriented properly on the tooth stump prostheses.

This provides a means for preventing the veneers from being placed on the wrong tooth stump prostheses and for preventing the veneers from being affixed on the tooth stump prostheses at the wrong orientation.

The underlying objects of the present invention are also met through a denture, in which multiple tooth stump prostheses are affixed in a prosthetic baseplate or are structured to be the same part as the prosthetic baseplate and a veneer to be affixed in coronal position on at least one tooth stump prosthesis, preferably a veneer to be affixed in coronal position on each tooth stump prosthesis.

Preferably, the denture is fabricated through a method according to the invention.

The invention can just as well provide the veneers to consist of a ceramic or a plastic material, preferably of PMMA.

It is preferable for the veneer to be glued onto the tooth stump prosthesis and/or the veneers to be glued onto the tooth stump prostheses.

It is true of all dentures according to the invention that they can preferably also comprise material apparatus features of methods according to the invention and apparatus features resulting from the procedural steps.

The invention is based on the surprising finding that, using veneers and taking into consideration their dimensions and preferably their shape also, the prosthetic baseplate needs to be fitted only with tooth stump prostheses, which can subsequently be fitted with the veneers. The use of the veneers allows the aesthetic impression of the denture to be improved and just generally there is more freedom in the selection of the material as compared to a prosthesis that is fabricated fully through a CAM method. Concurrently, the method according to the invention also allows the advantages of denture production by means of a CAD-/CAM method to be utilised. This allows an accurate, rapidly available denture to be produced inexpensively, while at the same time being able to meet the strict requirements in terms of the aesthetic appearance and the physical properties of the material (such as high hardness and low surface roughness and/or smooth surface).

The principle provides maximal flexibility in the digital production of partial and full dentures with respect to the set-up of the teeth. No classical stock teeth in need of being ground basally are used. The aesthetics and mastication function are attained through thin, pre-fabricated veneers.

A coarse tooth stump prosthesis of the colour of teeth (uni- or multi-coloured) is designed by means of a CAD method and produced by CAM (milled or printed). In this context, the spatial relationships can be taken into account individually. In a second step, pre-fabricated thin veneers are plugged onto the pre-fabricated tooth stump prostheses and glued to them. The connection between the two elements is afforded, for example, by means of exactly defined small troughs in the tooth stump prostheses and/or through their counterparts in the veneers, similar to the LEGO principle.

### BRIEF DESCRIPTION OF THE DRAWING

Exemplary embodiments of the invention shall be illustrated in the following on the basis of one schematic FIGURE, though without limiting the scope of the invention. In this context,

FIG. 1 shows a schematic cross-sectional view through the jaw and the oral cavity of a patient, in which a denture according to the invention is inserted that has been manufactured through a method according to the invention.

An edentulous upper jaw 1 and an edentulous lower jaw 2 of the patient can be seen and the tongue 3 of the patient is shown in the oral cavity as well. The two-part denture sits on the dental arches. The foundation of the two parts of the denture essentially consists of one prosthetic baseplate 4 each for the upper jaw 1 and the lower jaw 2 resting on the edentulous dental arches. The prosthetic baseplates 4 have recesses for tooth stump prostheses 6 arranged in them, which are occupied by the tooth stump prostheses 6. The tooth stump prostheses 6 are glued into the recesses of the prosthetic baseplates 4.

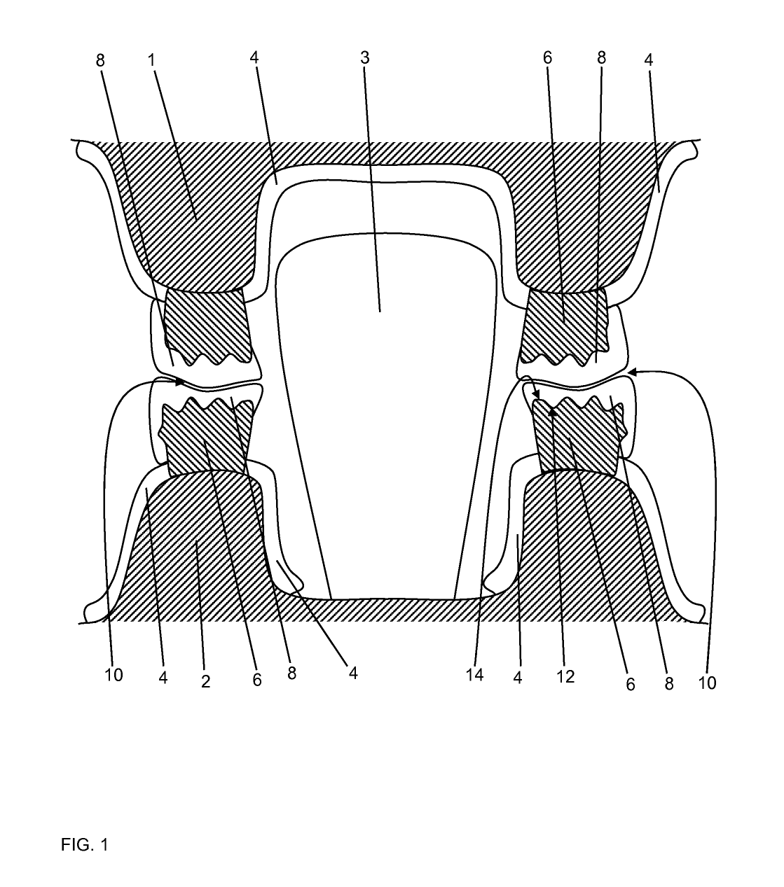

Veneers 8 made of a hard plastic material are arranged on the tooth stump prostheses 6 and form the mastication surface of the dental prostheses of the denture. In this context, FIG. 1 shows dental prostheses of molar teeth. The veneers 8 are bordered on their upper side by their occlusal surfaces (the mastication surfaces in the case of the molar teeth). The optimal positioning of all occlusal surfaces results in the desired occlusal plane 10 of the two parts of the denture. On the side opposite from the occlusal plane 10, the veneers 8 comprise a connecting surface 12 by means of which the veneers 8 are affixed by gluing on the coronal side 14 of the tooth stump prostheses 6. The coronal side 14 is structured. The connecting surface 12 of the veneers 8 is also structured and forms a negative image of the coronal surface 14 of the tooth stump prostheses 6 such that the veneers 8 are and/or can be connected to be two-dimensionally flush to the tooth stump prostheses 6.

The connecting surface 12 and the coronal upper side 14 being structured allows, on the one hand, for more stable connection of the veneers 8 to the tooth stump prostheses 6. On the other hand, having a structuring provides an opportunity for providing an indexing that prevents the veneers 8 from being affixable to the wrong tooth stump prostheses 6 and also prevents the veneers 8 from being affixed on the tooth stump prostheses 6 at a wrong orientation.

The desired optimal occlusal plane 10 is determined using known methods before the denture is produced. For example, the oral cavity itself or an impression thereof can be optically scanned and digitised, whereby the desired distance between the upper jaw and the lower jaw is adjusted in accordance with known parameters. If there are some residual natural teeth present, these can be used to determine the desired occlusal plane 10.

The scan of the oral cavity and/or the data of the three-dimensional surface of the alveolar ridges are used to generate two CAD models of the prosthetic baseplate 4. The recesses in the prosthetic baseplates 4 for the tooth stump prostheses 6 are already defined at this stage.

From a multitude of pre-fabricated veneers 8, the ones matching the patient best are selected or produced. The connecting surfaces 12 of the veneers 8 are known and stored as three-dimensional data on a computer. Theoretically, the connecting surfaces 12 of the veneers 8 can also be scanned as three-dimensional surface, digitised and used in the computation of the coronal surface of the tooth stump prostheses 6. The thickness values of the veneers 8 are also known or are to be determined and stored as data sets. A CAD method is used to determine the external shape of the tooth stump prostheses 6 from the positions of the tooth stump prostheses 6, the shape of the connecting surfaces 12 of the veneers 8 and the desired position of the occlusal plane 10 relative to the alveolar ridges of the upper jaw 1 and lower jaw 2. One also obtains CAD models for the tooth stump prostheses 6 aside from the CAD models for the prosthetic baseplates 4.

The CAD models are used to produce the prosthetic baseplates 4 and the tooth stump prostheses 6 using a CAM method. The prosthetic baseplates 4 and the tooth stump prostheses 6 can, for example, be milled out of solid bodies using a computer-guided multi-axis milling machine. However, it is preferable to print out the prosthetic baseplates 4 and the tooth stump prostheses 6 with a 3D printer and to produce them from PMMA (polymethylmethacrylate) directly. In this context, the prosthetic baseplates 4 are fabricated to be gum-coloured, whereas the tooth stump prostheses 6 are given a white or whitish hue.

After the tooth stump prostheses 6 have subsequently been glued into the prosthetic baseplates 4, the veneers 8 are glued onto the designated tooth stump prostheses 6. Alternatively, the tooth stump prostheses 6 can just as well be produced and/or printed together with the prosthetic baseplates 4 in order to prevent errors from occurring while connecting the parts and/or to save working steps.

The veneers 8 have the desired materials properties and the desired colouring as well as suitable optical properties (for example minor transparency in order to produce a close-to-real impression).

Once the adhesives are dried, the denture is finished and ready for use. Minor corrections of the positions of the prosthetic teeth in terms of the occlusal surface can be made subsequently by grinding away small amounts of the veneers 8 at the occlusal surfaces. However, since the CAD/CAM method for production of prosthetic baseplates 4 and tooth stump prostheses 6 is very exact, no more than small amounts need to be ground away.

The features of the invention disclosed in the preceding description and in the claims, figures, and exemplary embodiments, can be essential for the implementation of the various embodiments of the invention both alone and in any combination.

### LIST OF REFERENCE NUMBERS

1 Upper jaw

2 Lower jaw

3 Tongue

4 Prosthetic baseplate

6 Tooth stump prosthesis

8 veneer

10 Occlusal plane

12 Coronal surface of the tooth stump prosthesis with structuring

14 Connecting surface of the tooth stump prosthesis with structuring

1. A method for producing a denture, said method comprising producing a prosthetic baseplate and multiple tooth stump prostheses by applying a CAD model and affixing pre-fabricated veneers on the tooth stump prostheses, whereby thickness values of the veneers are taken into consideration during the generation of the CAD model of the tooth stump prostheses.

2. Method according to claim 1, wherein
axial lengths of the tooth stump prostheses of the CAD model are adjusted as a function of the thickness values of the veneers.

3. Method according to claim 1, wherein
the shape of connecting surfaces of the veneers are taken into consideration in the generation of the CAD model of the tooth stump prostheses.

4. Method according to claim 1, wherein
the axial lengths of the tooth stump prostheses thus generated are determined by the thickness of the veneers and the desired location of the occlusal plane of the denture with respect to the contact surface of the prosthetic baseplate.

5. Method according to claim 1, comprising, in chronological order, the following steps:
A recording the situation inside the oral cavity of a patient and determining the position of the desired occlusal plane in the oral cavity of said patient;
B digitising the recorded situation in the oral cavity and position of the desired occlusal plane;
C generating a virtual CAD model of the prosthetic baseplate and of the plurality of tooth stump prostheses, whereby the contact surface of the virtual CAD model of the prosthetic baseplate is determined based on the existing situation in the oral cavity;
D producing a prosthetic baseplate and a plurality of tooth stump prostheses based on the CAD model; and
E affixing the veneers on the tooth stump prostheses.

6. Method according to claim 5, wherein
at least the shape of the alveolar ridge surface of the upper jaw and/or of the lower jaw as well as its/their position(s) with respect to the occlusal plane is recorded and digitised as situation in the oral cavity, and in that the contact surface of the virtual CAD model of the prosthetic baseplate is computed from the digitised alveolar ridge surface.

7. Method according to claim 1, wherein
the tooth stump prostheses are produced based on the CAD model through the use of a CAM method and the veneers are affixed to the designated tooth stump prostheses.

8. Method according to claim 1, wherein
the prosthetic baseplate and the tooth stump prostheses are fabricated as separate parts with separate CAD models and the tooth stump prostheses thus produced are affixed to the prosthetic baseplate thus produced.

9. Method according to claim 1, wherein
one prosthetic baseplate each for the upper jaw and one prosthetic baseplate for the lower jaw are produced based on the same occlusal plane, and in that the denture is fabricated to have a denture component for the upper jaw and a denture component for the lower jaw.

10. Method according to claim 1, wherein
the veneers cover the tooth stump prostheses completely in occlusal direction.

11. Method according to claim 1, wherein
the prosthetic baseplate and/or the tooth stump prostheses are fabricated from a plastic material.

12. Method according to claim 1, wherein
the connecting surfaces of the veneers have an indexed structuring and the surfaces of the tooth stump prostheses provided for the connecting surfaces of the veneers have a matching indexed structuring, and the veneers are joined to the tooth stump prostheses via the indexed structured surfaces and the veneers are thus being oriented properly on the tooth stump prostheses.

13. A denture comprising multiple tooth stump prostheses affixed in a prosthetic baseplate or structured to be the same part as the prosthetic baseplate and a veneer affixed in coronal position on at least one tooth stump prosthesis.

14. Denture according to claim 13, wherein
the veneers consist of a ceramic or a plastic material.
